(19) United States
(12) Patent Application Publication
(10) Pub. No.: US 2026/0065365 A1
(43) Pub. Date: Mar. 5, 2026

(54) Debit Card Credit Builder

(71) Applicant: OMNIBEK IP HOLDING LLC, Holmdel, NJ (US)

(72) Inventor: Sergey Bekiyants, Holmdel, NJ (US)

(21) Appl. No.: 19/314,558

(22) Filed: Aug. 29, 2025

Related U.S. Application Data
(60) Provisional application No. 63/689,358, filed on Aug. 30, 2024.

(51) Int. Cl. G06Q 40/03; G06Q 20/26

(52) U.S. Cl. CPC G06Q 40/032; G06Q 20/26

(57) ABSTRACT

A financial system and method designed to help individuals build or repair their credit history through the use of a debit card includes building a credit history by leveraging direct deposits from ones employer to establish a line of credit. The line of credit can then be reported to credit bureaus regularly, thus enhancing a user's credit score. In one specific form, the financial system and method first establishes a credit line based on a user's direct salary deposit. A line of credit is then specifically established based on the amount of the direct deposit amounts. Regular reporting of purchase activities and balances are reported to credit bureaus such as Experian every two weeks for example.

### FIELD OF THE INVENTION

The present invention relates to a method and system for financial transactions and in particular a method and system for using a debit card to build consumer credit.

### BACKGROUND OF THE INVENTION

There are many conventional methods for making purchases or conducting financial transactions. Often transactions are made for purchases by transferring funds between a customer and a merchant by electronically transferring funds between a consumer's account and a merchant's account. For example, financial transactions for consumer purchases may be between a customer's credit card account and a merchant's bank account. Alternatively, a transaction may be between a customer's bank account such as a checking or savings account and the merchant's bank account. The transaction can be initiated using a debit card associated with the customer's savings or checking account.

One benefit for using a credit card for customer purchases is the building of consumer credit. For example, a credit card purchase transaction and its subsequent customer payment to the credit card company that pays off the debt incurred during the credit card purchase are reported to one or more credit bureaus. The reporting to the credit bureaus allows the customer to build a credit history using the credit card.

Unlike credit card purchases, debit card purchases are not reported to the credit bureaus. Consequently, purchases using a debit card do not build a customer credit history.

Although use of a debit card does not build a customer credit history, customers still may prefer to use a debit card rather than a credit card for purchases. Conventional debit cards do not allow a customer to make purchases beyond an amount in a customer's bank account. Accordingly, a customer using a debit card cannot get into debt. However, a disadvantage of using a debit card is that the debit card does not build a credit history and/or improve a customer credit score maintained at the credit bureaus.

A credit card company backed debit card such as a VISA debit card or MASTERCARD debit card allow customers'purchases using the money in their savings/checking accounts. However, purchases are not reported to the credit bureaus, and no credit history is build. Instead, purchases with a credit card issuer's debit card are reconciled from the customers'savings/checking accounts upon purchase and no credit extended to the customers.

Further, in today's financial landscape, a good credit score is crucial for accessing various financial services and opportunities. Many individuals, especially students and those with poor credit histories, face significant challenges in building or repairing their credit. Existing solutions like secured credit cards and credit-builder loans often come with high fees and interest rates and do not always effectively integrate with the user's regular financial activities.

### SUMMARY OF THE INVENTION

The present method and system are unique in using a debit credit card to build a credit history in a unique innovative way. The present method and system includes a financial product designed to help individuals build or repair their credit history through the use of a debit card. Unique aspects which provide for building credit history include leveraging direct deposits from ones employer to establish a line of credit. This line of credit can then be reported to credit bureaus regularly, thus enhancing a user's credit score. The method and system is particularly beneficial for students and individuals new to the credit system as well as those that may have previous poor credit.

The present method and system integrates a credit building function into a debit card in a unique way. The method and system, in one specific form, includes first establishing a credit line based on a user's direct salary deposit. A line of credit is specifically established based on the amount of the direct deposit amounts. Regular reporting of purchase activities and balances are reported to credit bureaus such as Experian every two weeks for example.

The present method in one specific form is directed to a unique method for building credit history using a bank account and an associated debit card. The method includes opening a bank account with a debit card issuer by a customer. The bank account has a bank account balance and an associated debit card. A line of credit account is created for the customer having an initial credit line account amount (i.e., line of credit) equal to the bank account balance. The debit card can be used for a purchase amount with a merchant in a purchase transaction. The purchase amount is transferred from the debit card issuer to the merchant. The purchase amount is deducted from the credit line account amount balance. An encumbered hold is placed on the bank account in the amount of the purchase price. This reduces the amount that the customer can withdraw from the bank account by the purchase price amount although an actual amount of money in the bank account remains at the bank account balance amount. Periodically, money is transferred from the bank account to the debit card issuer in an amount of the reductions to the credit line account balance thus restoring the credit line amount balance. The time period can be monthly, quarterly or weekly. The purchase transaction and restoration of credit line account amount balance is reported to one or more credit bureaus thus establishing a credit history for the customer with the one or more credit bureaus.

The present method in one further specific form includes establishing direct deposit between an employer for the customer and the bank account. Funds transferred to the bank account from the employer are made directly between the employer and the debit card issuer to replenish funds in the bank account.

In one further alternative form, the bank account (savings or checking) enables a customer to make withdraws from the bank account thus reducing the balance in the bank account by the amount of the withdrawal amounts and the credit line account balance is also reduced by the withdrawal amounts.

The present invention in another form thereof is directed to a method for receiving payment for a purchase price from a customer using a debit card. The method includes establishing a payment network between a merchant and a debit card issuer. The method further includes requesting payment by the merchant to the debit card issuer in an amount a customer is initiating a purchase transaction at the purchase price amount. The method further includes receiving payment by the merchant from the debit card issuer in the purchase price amount. Funds are transferred from the debit card issuer to the merchant from the debit card issuer account and not an account of the customer. The customer has a bank account from the debit card issuer. The bank account has a bank account balance and the debit card is associated with the bank account. The debit card issuer has created a credit line account for the customer having an initial credit line account amount equal to the bank account balance. The purchase amount is deducted from the credit line account amount balance. An encumbered hold is placed on the bank account in the amount of the purchase price thus reducing an amount the customer can withdraw from the bank account by the purchase price amount although the actual amount of money in the bank account remains at the bank account balance amount. Money is periodically transferred from the bank account to the debit card issuer in an amount of the reductions to the credit line account balance thus restoring the credit line account balance. The transfer period can be monthly, quarterly or weekly. The debit card issuer reports to one or more credit bureaus the purchase transaction and restoration of credit line account amount balance thereby establishing a credit history for the customer with the one or more credit bureaus.

The present invention in another form thereof is directed to a system for building a credit history using a bank account and an associated debit bank card. The system includes a credit builder module associated with a debit card issuer. The credit builder module has a processor and computer memory. A plurality of network connections allows for connectivity between the credit builder module and customers, one or more credit bureaus and merchants. The credit builder module establishes a bank account with a debit card issuer for a customer. The bank account has a bank account balance and an associated debit card. The credit module hosts a credit line account for the customer having an initial credit line account amount equal to the bank account balance. The credit builder module further facilitates transfer of a purchase amount between the debit card issuer and a merchant in a purchase amount a consumer made a purchase transaction using the debit card. The credit builder module deducts the purchase amount from the credit line account amount balance and the credit builder module places an encumbered hold on the bank account in the amount of the purchase price thus reducing an amount the customer can withdraw from the bank account by the purchase price amount although an actual amount of money in the bank account remains at the bank account balance amount.

The credit builder module further periodically (e.g., monthly, quarterly or weekly) transfers money from the bank account to the debit card issuer in an amount of reductions to the credit line account balance thus restoring the credit line account balance. Further, the credit builder module reports to the credit bureau the purchase transaction and restoration of the credit line account amount balance thereby establishing a credit history for the customer with the credit bureau.

In one particular form, a user (e.g., customer) sets up a direct deposit between his or her employer and the present method and system to direct his or her salary either directly from his or her employer. This allows the present method and system to become the user's permanent account thus simplifying financial management for the user.

In another particular form, the present method and system has credit score enhancement to help users, especially students and those new to credit to build and enhance credit scores.

In yet another particular form, the present method and system combines a debit card functionality with credit building features.

### BRIEF DESCRIPTION OF THE DRAWINGS

The present method and system will now be described with reference to the drawings as discussed below:

FIG. 1 is a schematic of one aspect of the present method.

FIG. 2 is a general flowchart of one method in accordance with the present disclosure.

FIG. 3 is a schematic of a system for implementing a debit card credit builder in accordance with one aspect of the present invention.

FIG. 4 is a flowchart in accordance with the present debit card credit builder.

FIG. 5 is another flowchart in accordance with the present debit card credit builder with reference to the system of FIG. 3.

FIG. 6 is another flowchart in accordance with the present debit card credit builder with reference to the system of FIG. 3.

FIG. 7 is another flowchart of a method in accordance with the present disclosure with reference to the system of FIG. 3.

FIG. 8 is another flowchart of a method in accordance with the present disclosure with reference to the system of FIG. 3.

### DETAILED DESCRIPTION OF THE INVENTION

The following terms and abbreviations are used throughout this disclosure:
account holder (AH)—a user or customer who owns the bank account with associated debit card
automatic teller machine (ATM)—an actual machine and/or ATM network
bank account—a checking or savings account hosted by the debit card issuer on behalf of a user/customer
bank account balance—amount of funds in the bank account that a user/customer can withdraw
credit line account—an account with the debit card issuer that has a balance from which money is used to make purchases
credit line account balance—amount of credit associated with the credit line account
debit card—a bank card that a user can use to make purchases with a merchant
debit card issuer—a financial institution (FI) such as a bank, credit union, etc.
direct deposit account (DDA)—the bank account having been configured to receive direct deposits from a user's employer to the FI
line of credit (LOC)—credit extended to a user/customer by the FI based on balance in the bank account
merchant—entity or business a user presents the debit card for purchase using the LOC backed by the bank account balance
operator—the debit card issuer implementing this method/system
purchase amount/purchase price—the amount of an item a user wishes to purchase which is subsequently paid by the FI and amount deducted from the credit line account balance in the credit line account
purchase transaction—a transaction between merchant and the debit card issuer when an account holder uses the debit card to make a purchase
restoration of credit line account balance—amount of credit added back to the credit line account balance when money is transferred from the bank account to the debit card issuer during periodic payments
vendor—a commercial entity that provides the functionality to allow an Account Holder to: (1) set up a new direct deposit of all or part of their payroll to Inventor's system; or (2) change all or part of the amount of their direct deposit which is going to the present system.

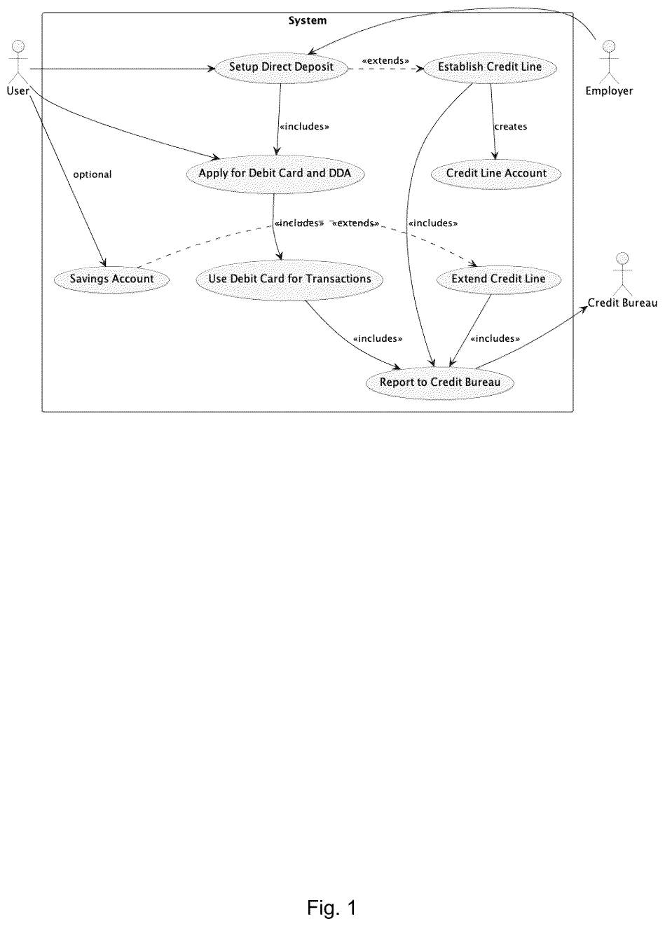

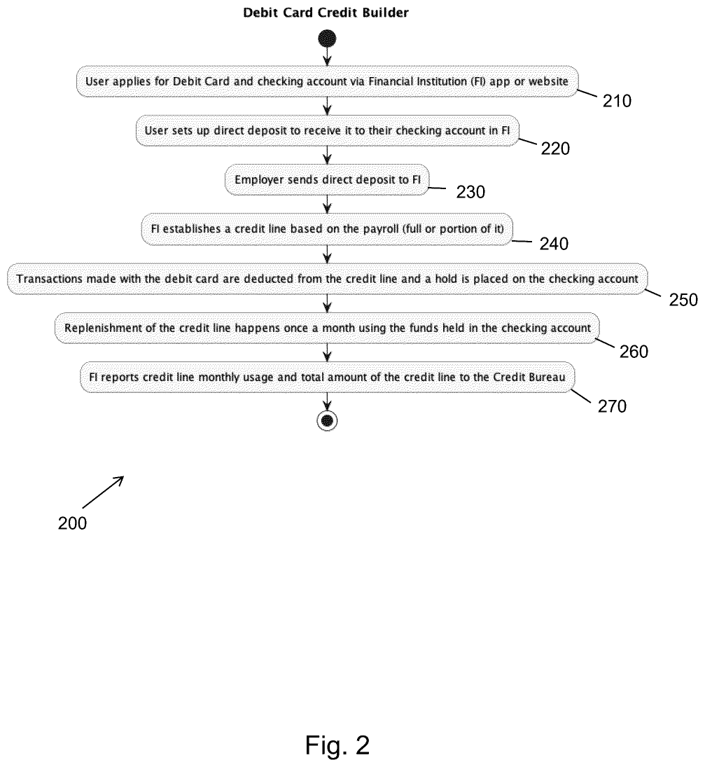

Referring to the Figures in order to have a better understanding of the present method and system. FIG. 1 is a high level schematic of a system for implementing the present debit card credit building method. FIG. 2 is a general flowchart describing how the present method and system builds credit using a debit card in accordance with the invention disclosure.

A user first applies for a debit card and a bank account such as a savings or checking account. The user then sets up direct deposit between his or her employer and the bank account. As is conventional, deposits are made to the direct deposit account from the employer based on the users pay period.

The present method and system then establishes a line of credit corresponding to the amount of the direct deposits. This line of credit is what is used when a user uses his or her debit card to make purchases.

One unique distinction over prior known financial transactions is the use of a line of credit for purchases made by a user rather than withdrawing money from the users bank account upon purchases using the present debit card. Instead, the financial institution (e.g., bank) implementing the present method and system (e.g., operator) pays a merchant on behalf of the user from the line of credit. This allows the present method and system to use the transaction as evidence of payment using a line of credit which can then be reported to the credit bureaus. Doing so, thereby establishes and builds a credit history for the debit card holder/user.

Although the financial institution (bank/operator) is the one making the payment from the line of credit and not a direct withdrawal from the users account, the financial institution does deduct the amount of the user's purchase from the line of credit and the corresponding purchase amount is placed as a hold on the bank (checking/savings) account. For example, if the checking account has $1,000 in it and a user purchases a product for $100, the financial institution will pay the $100 to the merchant and a hold of $100 is placed on the checking account but the $100 has not been withdrawn or deducted from the account. Merely the user can only withdraw $900 from the account and the user's line of credit in now reduced to $900.

On a periodic basis, such as monthly, the line of credit is updated as direct deposits are made to the account and as the user authorizes payment of the credit transactions from her or her bank account. Thus the “hold” results in payment to satisfy the amount the financial institution has paid to various merchants throughout the pay period on the users behalf.

It will now be appreciated that the present debit card functions differently from credit card backed debit cards such as a VISA debit card which transfers money between a debit card owner's bank account and its issuer at the time a purchase is made. Instead, the present debit card transaction are batched, and subsequently at a time in the future period, all the amounts of all transactions in that period are transferred from the user's bank account and the debit card issuer to satisfy the credit extended to the user used for the purchases.

Referring to the method of FIG. 2 in further detail, method 200 includes having a user apply for a debit card and a bank account with a financial institution (FI) such as a bank (Step 210). The financial institution (FI) is also referred to as the debit card issuer (Step 210). The bank account can be a checking account or a savings account (Step 210).

The user, such as a customer of the FI, sets up direct deposit between his or her employer and the FI allowing the FI to receive direct deposit payments into the bank account (Step 220).

The employer sends direct deposit payments to the FI (Step 230).

The FI establishes a line of credit for the customer based on the payroll the employee receives from the employer which may be full or a portion of the payroll amount made in the direct deposits (Step 240).

The user/customer can make purchases, i.e., transactions, using the debit card (Step 250). The purchase price or amount of the transactions are deducted from the credit line and a hold is placed on the bank account (Step 250). For example, the FI creates a credit line account for the user/customer having an initial credit line account amount equal to the bank account balance (Step 240). The debit card is used by the customer with a merchant for a purchase amount equal to the purchase transaction price (Step 250). The purchase amount is transferred from the FI to the merchant (Step 250). The purchase amount is deducted from the credit line account amount balance and an encumbered hold is placed on the bank account in the amount of the purchase price (Step 250). This reduces the amount that the user/customer can withdraw from the bank account by the purchase price amount although an actual amount of the money in the bank account remains at the bank account balance amount (Step 250).

Money is periodically transferred from the bank account to the FI in an amount of reductions to the credit line account balance thus restoring the credit line account balance (Step 260). The period can be a traditional monthly basis (Step 260). However other time periods can be used including weekly or quarterly (Step 260).

The FI reports to one or more credit bureau, the purchase transaction and the restoration of the credit line account amount balance thereby establishing a credit history for the customer with the credit bureau(s) (Step 270).

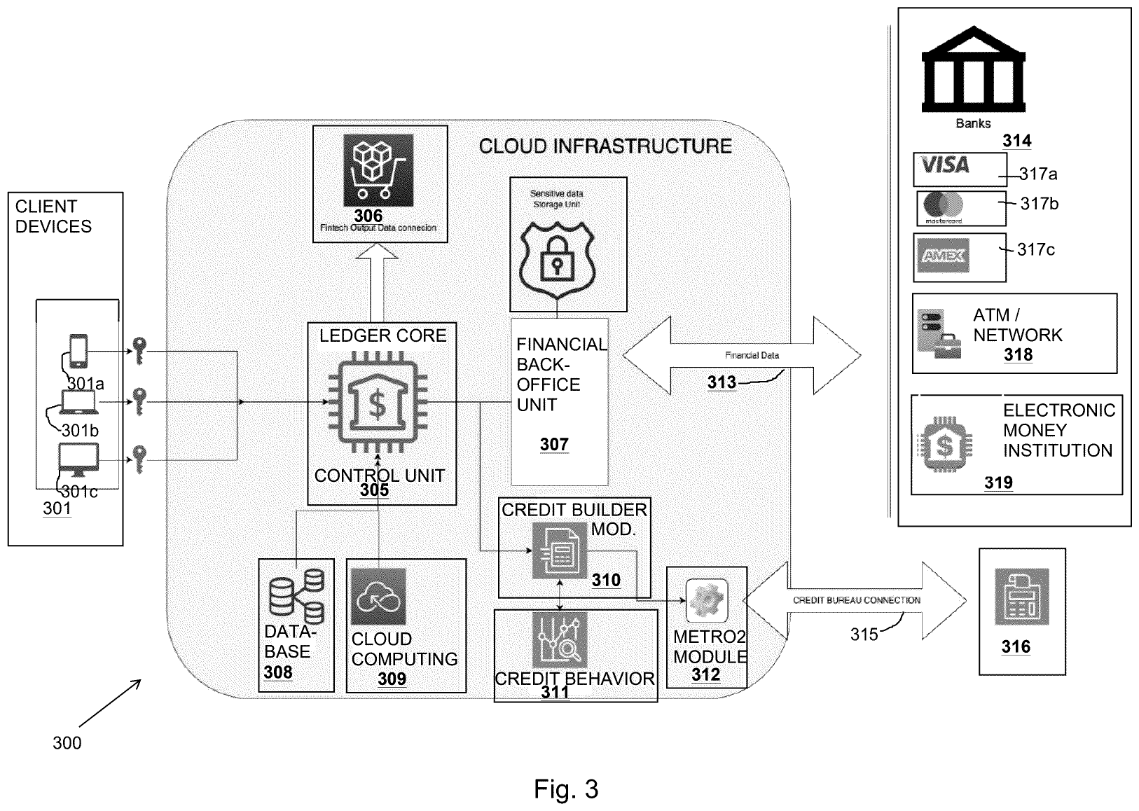

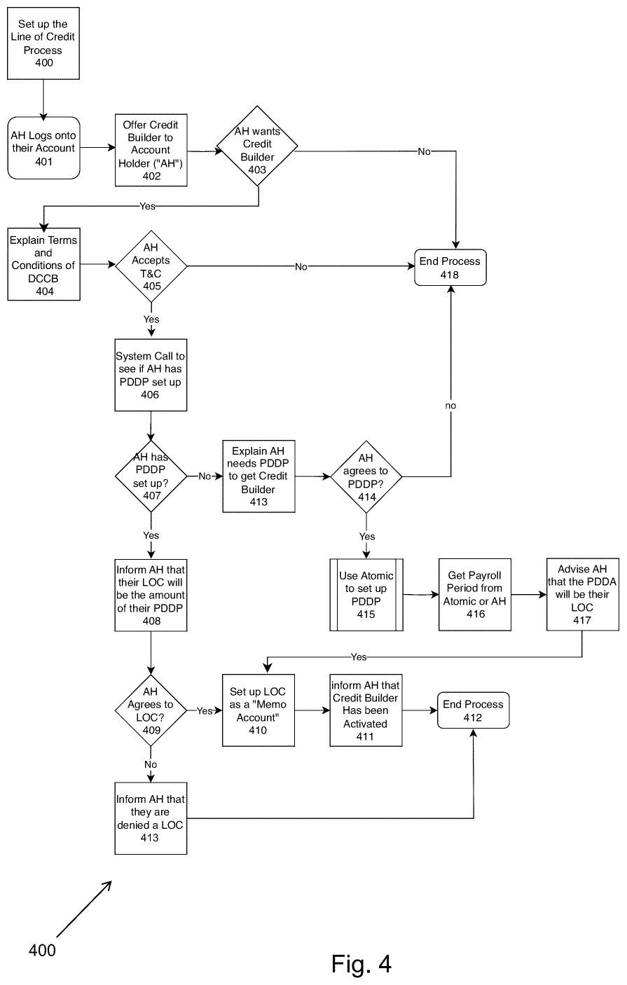

The present method will now be described with reference to the system 300 of FIG. 4 along with system 300 of FIG. 3. System 300 can also be used to implement method 200 (FIG. 2) as well as method 400 of FIG. 4.

Referring now to the method of FIG. 4 along with the system 300 of FIG. 3, assumptions are that: (i) individual has a direct deposit bank account and a debit card; and (ii) a customer/cardholder chooses to be provided information about a debit card credit builder program on the app on their smartphone, and the account holder (AH) has already set up a periodic direct deposit payment.

### Setting Up the Line-of-Credit Process

A line of credit account user (“account holder”) signs onto their account using their personal device 301, i.e., a client device such as a personal smartphone 301a, a laptop 301b or a desktop 301c. A ledger core control unit 305 makes a call to the opt-in-offering which resides on a database 308 and displays the opt-in-option for the debit card credit builder program to the account holder on the same device the account holder logged onto the system 300, their personal device 301 (Steps 401-402).

The account holder (user/customer) indicates that he or she is interested in a debit card credit builder (“DCCB”) program. The ledger core control unit 305 makes a call to the DCCB-offering via the credit builder module 310 and displays a comprehensive description of DCCB to the account holder back to the device the account holder signed onto the system 300, i.e., their personal device 301 (Step 403).

The account holder replies that they would like to participate in DCCB back to the system 300, which is running on the ledger core control unit 305 via their personal device 301. The system 300 makes a call to the DCCB-terms-and-conditions which are housed on the database 308 via the Amazon web services (“the Cloud Computing”) 309 and displays the DCCB terms and conditions back to the account holder via the device that the account holder signed onto the system 300, i.e., their personal device 301. (Step 404).

The account holder indicates, via their personal device 301 that they accept the terms and conditions. The ledger core control unit 305 makes a call to the DCCB-T&C-file which resides on the database 308, and records that the account holder has accepted the terms and conditions of DCCB (Step 405).

The ledger core control unit 305 makes a call to the account holder's data record which resides on the database 308, to see if the account holder has already set up a periodic direct deposit payment (“PDDP”) to the account holder's account (Step 406).

The ledger core control unit 305 returns a positive response to the account holder via their personal device 301 that the account holder has a PDDP set up on the database 308 (Step 407).

As the account holder has a PDDP set up, the system 300, which is running on the ledger core control unit 305 informs the account holder via their personal device 301 that their line-of-credit (“LOC”) will be the amount of their PDDP and does the account holder agree. The account holder must indicate that they agree by sending a return message to the system 300, which is running on the ledger core control unit 305 via their personal device 301 (Step 408).

The system 300, which is running on the ledger core control unit 305 makes a call to the account holder's data file, which resides on the database 308 and indicates that the account holder has agreed (Step 409).

The system 300, which is running on the ledger core control unit 305 makes a call to the account holder's account, which resides on the database 308 that the account holder has a PDDP, and sets up a memorandum LOC file that the account holder has a LOC equal to their PDDP (Step 410).

The system 300, which is running on the ledger core control unit 305 prepares a message to the account holder that the account holder now has a LOC equal to their PDDP and sends the message to the account holder via their personal device 301 (Step 411).

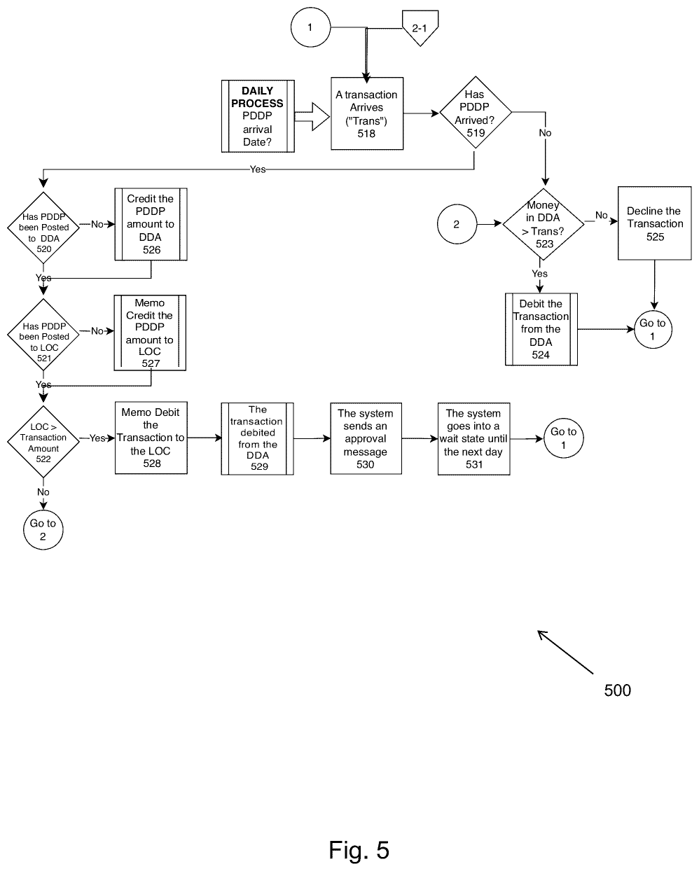

Referring now to the method of FIG. 5 along with the system of FIG. 3, the system 300, which is running on the ledger core control unit 305, returns a positive response to the account holder via their personal device 301 that the account holder has a PDDP set up on the database 308 (Step 507).

In an alternative method, the following assumptions are made: (i) individual has an financial institute DDA and a debit card; and (ii) a customer/cardholder chooses to be provided information about our debit card credit builder program on the APP on their smartphone, and account holder has already set up a periodic direct deposit payment, but declines the PDDP to be the amount of the LOC.

### Setting Up the Line-of-Credit Process

The account holder signs onto their account using their personal device 301. The ledger core control unit 305 makes a call to the opt-in-offering and displays the opt-in-option for the debit card credit builder program to the account holder (Steps 401-402).

The account holder indicates that they are interested in the debit card credit builder (“DCCB”) program. The ledger core control unit 305 makes a call to the DCCB-offering which resides on the database 308 and displays a comprehensive description of DCCB to the account holder on their personal device 301 (Step 403).

The account holder using their personal device 301 indicates that they would like to participate in DCCB. The ledger core control unit 305 makes a call to the DCCB-terms-and-conditions which resides on the database 308 and displays the DCCB terms and conditions to the account holder on their personal device 301 (Step 404).

The account holder indicates on their personal device 301 that they accept the terms and conditions. The system 300, which is running on the ledger core control unit 305 makes a call to the DCCB-T&C-file which resides on the database 308 and records that the account holder has accepted the terms and conditions of DCCB (Step 405).

The ledger core control unit 305 makes a call to the account holder's data record which resides on the database 308 to see if the account holder has already set up a periodic direct deposit payment (“PDDP”) to the account holder's account (Step 406).

The ledger core control unit 305 returns a positive response that the account holder has a PDDP setup on their personal device 301 (Step 407).

As the account holder has a PDDP set up, the ledger core control unit 305 informs the account holder on their personal device 301 that their line-of-credit (“LOC”) will be the amount of their PDDP and does the account holder agree? The account holder must indicate that they agree by returning a message to the ledger core control unit 305, using their personal device 301 (Step 408).

The ledger core control unit 305 makes a call to the account holder's data file which resides on the database 308 and indicates that the account holder declined the LOC (Step 409).

The ledger core control unit 305 delivers a message to the account holder on their personal device 301 that they are turned down for the LOC (Step 413).

In an alternative method, the following assumptions are made: (i) individual has an financial institution DDA and a debit card; and (ii) a customer/cardholder chooses to be provided information about our debit card credit builder program on the app on their smartphone, and account holder has already set up a periodic direct deposit payment, but declines the PDDP to be the amount of the LOC.

### Setting Up the Line-of-Credit Process

The account holder signs onto their account using their personal device 301. The ledger core control unit 305 makes a call to the opt-in-offering which resides on the database 308 and displays the opt-in-option for debit card credit builder to the account holder on their personal device 301 (Step 403).

The account holder, using their personal device 301 indicates that they would like to participate in DCCB. The ledger core control unit 305 makes a call to the DCCB-terms-and-conditions which resides on the database 308 and displays the DCCB terms and conditions to the account holder on their personal device 301 (Step 404).

The account holder on their personal device 301 indicates that they accept the terms and conditions. The ledger core control unit 305 makes a call to the DCCB-T&C-file which resides on the database 308 and records that the account holder has accepted the terms and conditions of DCCB (Step 405).

The ledger core control unit 305 makes a call to the account holder's data record which resides on the database 308 to see if the account holder has already set up a periodic direct deposit payment (“PDDP”) to the account holder's account (Step 406).

The ledger core control unit 305 initiates a call to the database which resides on the database 308 indicating that the account holder has not set up a PDDP (Step 407).

As the account holder has not set up a PDDP, the ledger core control unit 305 informs the account holder on their personal device 301 that they must set up a PDDP (Step 413).

Account holder on their personal device 301 agreed to do a PDDP (Step 414).

The ledger core control unit 305 links the account holder on their personal device 301 to the debit card issuer's via the cloud computing link, and the account holder works with the vendor to transfer some or all of their periodic payroll to the financial institute. The vendor via the cloud computing link, links the account holder back to the financial institute's environment (Step 415).

The system 300, which is running on the ledger core control unit 305 receives from the vendor via the cloud computing link the amount of the PDDP and the date(s) that the PDDP will be sent to the financial institution (Step 416).

The ledger core control unit 305 makes a call to the account holder's record which resides on the database 308 and indicates that the PDDP will be the account holder's LOC (Step 417).

The ledger core control unit 305 makes a call to the account holder's account which resides on the database 308 that the account holder has set up a PDDP and sets up a memorandum LOC file that the account holder has a LOC equal to their PDDP (Step 410).

The ledger core control unit 305 prepares and sends a message to the account holder on their personal device 301 that the account holder now has a LOC equal to their PDDP (Step 411).

LOC has been set up (Step 412).

A daily process is set up to run to handle any point of sale (POS)/automatic teller machine (ATM) debits that have arrived during the processing day. The processing day is set to be 00:00:01 through 24:00:00 each day.

In an alternative method, the following assumptions are made: (i) individual has an financial institution DDA and a debit card; and (ii) a customer/cardholder chooses to be provided information about our debit card credit builder program on the app on their smartphone, and the account holder has already set up a periodic direct deposit payment, but declines the PDDP to be the amount of the LOC.

Referring now to the method 500 (FIG. 5) along with system 300 (FIG. 3), a transaction process is described below.

### Process a Transaction Process

The account holder has made a purchase or withdrawn funds from an ATM 319, and the transaction arrives in the system 300, which is running on the ledger core control unit 305, via the financial backoffice unit 307 and the financial data link 313 (Step 518).

The ledger core control unit 305, issues a call to the account holder's account record which resides on the database 308 to see if the account holder has received the PDDP on the recorded arrival date and what action has been taken. The result of the system 300 call to the account holder's account record indicated a PDDP has arrived (Step 519).

The result is processed by the ledger core control unit 305 by making a call to the account holder's account record which resides on the database 308 indicating a PDDP has been posted to the account holder's DDA (Step 520).

The ledger core control unit 305 makes a call to the account holder's account record which resides on the database 308 indicating a PDDP has been posted to the account holder's LOC (Step 521).

The ledger core control unit 305 makes a call to the account holder's account record which resides on the database 308 indicating that the LOC is greater than the transaction amount (Step 522).

The ledger core control unit 305 makes a memo debit of the transaction amount to the LOC which resides on the database 308 (Step 528).

The ledger core control unit 305 debits the transaction amount from the account holder's DDA which resides on the database 308 (Step 529).

The ledger core control unit 305 informs various financial institutions and systems 314 as appropriate such as Visa system 317a, MasterCard 317b, American Express 317c, possibly using ATM Networks 318, electronic money institutions 319, financial backoffice unit 307 and the financial data link 313 that the transaction has been approved (Step 530).

The ledger core control unit 305 goes into a wait state until the next processing day (Step 531). The transaction processing action is complete (Step 531).

This is a daily process that the system 300 has to run to handle any POS/ATM debits that have arrived during the processing day. The processing day is set to be 00:00:01 through 24:00:00 each day.

### Process a Second Transaction

The account holder has made a purchase or withdrawn funds from an ATM 319 and the transaction arrives at the ledger core control unit 305, via the financial backoffice unit 307 and the financial data link 313 (Step 518).

The ledger core control unit 305 issues a call to the account holder's account record which resides on the database 308 to see if the account holder has received the PDDP on the recorded arrival date and what action has been taken (Step 519).

The ledger core control unit 305 makes a call to the account holder's account record which resides on the database 308 indicating a PDDP has arrived but has not been posted to the account holder's DDA which resides on the database 308 (Step 520).

The ledger core control unit 305, issues a call to the account holder's Account which resides on the database 308 to post the PDDP to the account holder's DDA which resides on the database 308 (Step 526).

The ledger core control unit 305 issues a call to the account holder's account which resides on the database 308 to see if the PDDP has been posted to the LOC (Step 521).

As the PDDP has not been posted to the account holder's LOC, the ledger core control unit 305, posts a credit to the LOC which resides on the database 308 (Step 527).

The ledger core control unit 305 makes a call to the account holder's account record which resides on the database 308 indicating that the LOC which resides on the database 308 is greater than the transaction amount (Step 522).

The ledger core control unit 305 makes a memo debit of the transaction amount to the LOC which resides on the database 308 (Step 528).

The ledger core control unit 305 debits the transaction amount from the account holder's DDA which resides on the database 308 (Step 529).

The ledger core control unit 305 informs, e.g., the Visa system 317 via financial backoffice unit 307 and the financial data link 313 that the transaction has been approved (Step 530).

The ledger core control unit 305, goes into a wait state until the next processing day (Step 531).

As a result, the transaction processing action is now complete.

### Process a Third Transaction

The account holder has made a purchase or withdrawn funds from an ATM 318 and the transaction arrives at the ledger core control unit 305, via the financial backoffice unit 307 and the financial data link 313 (Step 518).

The ledger core control unit 305 issues a call to the account holder's account record which resides on the database 308 to see if the account holder has received the PDDP on the recorded arrival date and what action has been taken (Step 519).

The ledger core control unit 305 makes a call to the account holder's account record which resides on the database 308 indicating a PDDP has not arrived (Step 519).

The ledger core control unit 305 checks to see if there is sufficient funds in the account holder's account which resides on the database 308 in order to honor the transaction (Step 523).

As there is enough funds in the account holder's DDA account to cover the transaction amount, the ledger core control unit 305 issues a call to the account holder's account which resides on the database 308 to debit the amount of the transaction. The third transaction processing action is now complete (Step 523).

### Processing a Fourth Transaction

The account holder using their financial institute's debit card, has made a purchase or withdrawn funds from an ATM 318 and the transaction arrives in the financial institute's system, which is running on the ledger core control unit 305, via the financial backoffice unit 307 and the financial data link 313 (Step 518).

The ledger core control unit 305 issues a call to the account holder's account record which resides on the database 308 to see if the account holder has received the PDDP on the recorded arrival date and what action has been taken (Step 519).

The ledger core control unit 305 makes a call to the account holder's account record indicated a PDDP has not arrived (Step 519).

The ledger core control unit 305 checks to see if there is sufficient funds in the account holder's account which resides on the database 308 in order to honor the transaction (Step 523).

As there are not enough funds in the account holder's DDA account which resides on the database 308 to cover the transaction amount, the ledger core control unit 305 issues a call to the account holder's account which resides on the database 308 to decline the transaction and sends a message to the ATM 319 via the financial backoffice unit 307 and the financial data link 313 that the transaction has been declined. The fourth transaction processing action is complete.

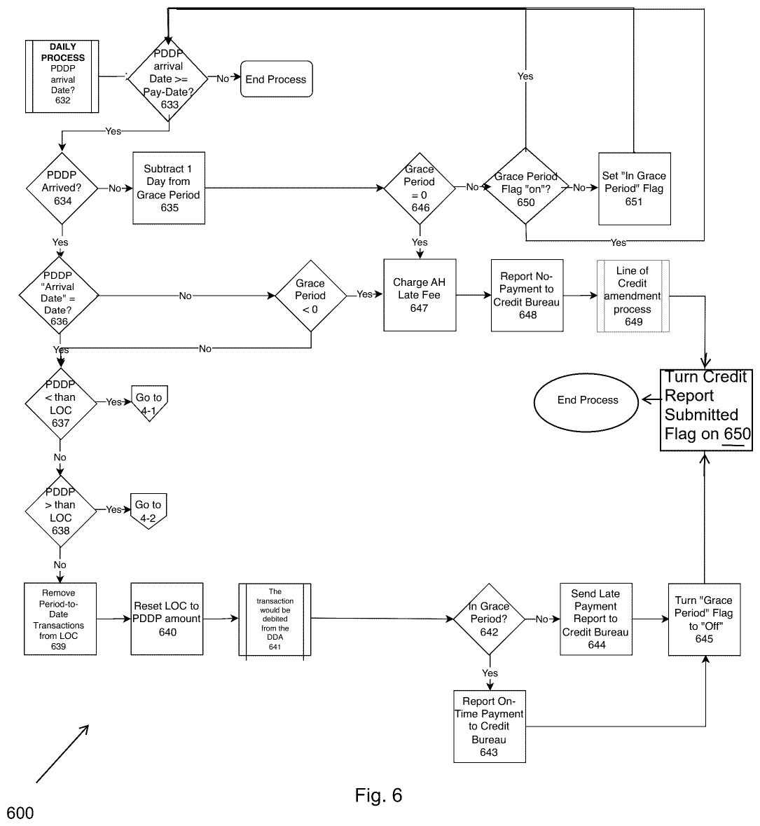

Referring to FIG. 6 along with FIG. 3, method 600 takes place on a daily basis to check if PDDP's have arrived before, on or after the date that the PDDP is scheduled to arrive.

### Daily Process for Credit Builder

The ledger core control unit 305 initiates a call to an account holder's account which resides on the database 308 to see if the scheduled PDDP arrival date has passed or is equal to today's date which would be accessed from the system 300 (Step 633).

The ledger core control unit 305 issues a call to the account holder's account record which resides on the database 308 to see if the scheduled PDDP has arrived (Step 634).

The ledger core control unit 305 issues a call to the account holder's account record which resides on the database 308 to see if the PDDP date is today's date which would be accessed from the system 300 (Step 635).

The ledger core control unit 305 issues a call to the account holder's account record which resides on the database 308 to see if the PDDP amount is less than the LOC which resides on the database 308 (Step 636).

The ledger core control unit 305 issues a call to the account holder's account record which resides on the database 308 to see if the PDDP amount is more than the LOC which resides on the database 308 (Step 637).

The ledger core control unit 305 issues a call to the account holder's account record which resides on the database 308 to remove the period-to-date transactions from the LOC which resides on the database 308 (Step 638).

The ledger core control unit 305 issues a call to the account holder's account record which resides on the database 308 to reset the LOC which resides on the database 308 to the PDDP amount (Step 639).

NOTE: The transactions would already have been debited from the account holder's DDA which resides on the database 308 (Step 640).

The ledger core control unit 305 issues a call to the account holder's account record which resides on the database 308 to see if the PDDP arrived during the grace period which resides on the database 308 (Step 641).

The ledger core control unit 305 reports and on-time payment to one or more credit bureaus 316 such as Experian 316a, via the credit builder module 310 and the Metro2 module 312 and the credit bureau connection 315 (Step 642).

The ledger core control unit 305 turns off the “grace period flag” in the account holder record which resides on the database 308 (Step 644). The process then terminates.

Referring to another process or transaction, this process takes place on a daily basis to check if PDDP's have arrived before, on or after the date that the PDDP is scheduled to arrive. In this process, the PDDP has not arrived on time and the system 300 evaluates if the PDDP is in the grace period.

### Daily Process for Credit Builder

The ledger core control unit 305 initiates a call to an account holder's account which resides on the database 308 to see if the scheduled PDDP arrival date has passed or is equal to today's date (Step 633).

The ledger core control unit 305 subtracts 1 from the number of days in the grace period which resides on the database 308 (Step 645).

The ledger core control unit 305 issues a call to the account holder's account record which resides on the database 308 to see if the grace period has reached 0. If it has (Step 646).

The ledger core control unit 305 issues a call to the account holder's account record which resides on the database 308 to charge the account holder a “late fee”which resides on the database 308 (Step 647).

The ledger core control unit 305 provides a “late payment” transaction to Experian 316a or any other credit bureau 316 via the credit builder module 312 and the Metro2 module 312 and the credit bureau connection 315 (Step 652).

Financial institution management reviews the account holder's payment records and decides if the account holder's LOC which resides on the database 308 should be cancelled or lowered (Step 653). The method then terminates.

In another process, the process takes place on a daily basis to check if PDDP's have arrived before, on or after the date that the PDDP is scheduled to arrive. In this process, the PDDP has not arrived on time and the system 300 evaluates if the PDDP is in the grace period.

### Daily Process for Credit Builder

The ledger core control unit 305 initiates a call to an account holder's account which resides on the database 308 to see if the scheduled PDDP arrival date has passed or is equal to today's date (Step 633).

The ledger core control unit 305 issues a call to the account holder's account record which resides on the database 308 to see if the scheduled PDDP has arrived (Step 634).

The ledger core control unit 305 subtracts 1 from the number of days in the account holder's grace period which resides on the database 308 (Step 635).

The ledger core control unit 305 issues a call to the account holder's account record which resides on the database 308 to see if the account holder's grace period which resides on the database 308 has reached 0. If it has not (Step 646).

The ledger core control unit 305 issues a call to the account holder's account record which resides on the database 308 to see if the grace period flag which resides on the database 308 is set to “on”. If it is not: 150.

The ledger core control unit 305 issues a call to the account holder record which resides on the database 308 to set the grace period flag to “in” which resides on the database 308 to “on”(Step 651). End of this process.

Another process takes place on a daily basis to check if PDDP's have arrived before, on or after the date that the PDDP is scheduled to arrive. In this process, the PDDP has not arrived on time and the system 300 evaluates if the PDDP is in the grace period.

### Daily Process for Credit Builder

The ledger core control unit 305 initiates a call to an account holder's account which resides on the database 308 to see if the scheduled PDDP arrival date has passed or is equal to today's date (Step 633).

The ledger core control unit 305 issues a call to the account holder's account record which resides on the database 308 to see if the scheduled PDDP has arrived (Step 634).

The ledger core control unit 305 subtracts 1 from the number of days in the account holder's grace period which resides on the database 308 (Step 635).

The ledger core control unit 305 issues a call to the account holder's account record which resides on the database 308 to see if the account holder's grace period which resides on the database 308 has reached 0. If it has not (Step 646).

The ledger core control unit 305 issues a call to the account holder's account record which resides on the database 308 to see if the grace period flag which resides on the database 308 is set to “on”. If it is has: 150. The method 600 then terminates.

The ledger core control unit 305 initiates a call to an account holder's account which resides on the database 308 to see if the scheduled PDDP arrival date has passed or is equal to today's date (Step 633). The ledger core control unit 305 issues a call to the account holder's account record which resides on the database 308 to see if the scheduled PDDP has arrived (Step 634).

The ledger core control unit 305 subtracts 1 from the number of days in the account holder's grace period which resides on the database 308 (Step 635).

The ledger core control unit 305 issues a call to the account holder's account record which resides on the database 308 to see if the account holder's grace period which resides on the database 308 has reached 0. If it has (Step 646).

The ledger core control unit 305 issues a call to the account holder's account record which resides on the database 308 and charges the account holder a late fee (Step 647).

The ledger core control unit 305 reports a “no payment” to Experion 316a and any other credit bureaus 316 via the credit builder module 310 and the metro2 module 312 and the credit bureau connection 315 (Step 648).

Financial Institution management reviews the account holder's payment records and decides if the account holder's LOC which resides on the database 308 should be cancelled or lowered (Step 649).

Next, a “Credit Report Submitted” flag is turned on noting a Credit Report has been submitted during the Daily Process (Step 650). Every account that has a LOC must be checked to see if a Credit Report is to be submitted (Step 650).

The method 600 then terminates.

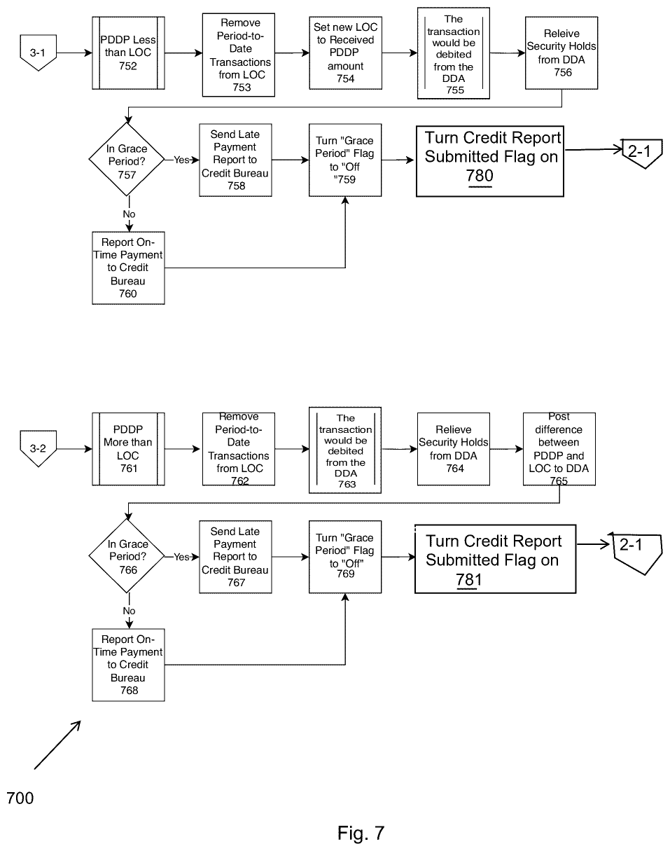

Referring now to the method 700 of FIG. 7 with system 300 of FIG. 3, this process takes place on a daily basis to check if PDDP's have arrived before, on or after the date that the PDDP is scheduled to arrive.

### Daily Process for Credit Builder

In this case the PDDP is less than the LOC which resides on the database 308 (Step 752).

The ledger core control unit 305 issues a call to the account holder's account record which resides on the database 308 to remove the period-to-date transactions from the LOC which resides on the database 308 (Step 753).

The ledger core control unit 305 issues a call to the account holder's account record which resides on the database 308 to set a new LOC to be equal to the received PDDP amount (Step 754).

The ledger core control unit 305 issues a call to the account holder's account record which resides on the database 308 to debit the transactions from the account holder's DDA, which resides on the database 308 (Step 755).

The ledger core control unit 305 issues a call to the account holder's account record which resides on the database 308 to release the security holds from the account holder's DDA, which resides on the database 308 (Step 756).

The ledger core control unit 305 issues a call to the account holder's account record which resides on the database 308 to see if the transaction is in the grace period, which resides on the database 308; if so (Step 757).

The ledger core control unit 305 reports a “late payment” to Experion 316 and any other credit bureaus 316 via the credit builder module 310 and the Metro2 module 312 and the credit bureau connection 315 (Step 758).

The ledger core control unit 305 issues a call to the account holder's account which resides on the database 100 to turn the grace period flag which resides on the database 100 to “off”(Step 759).

Next, a “Credit Report Submitted” flag is turned on noting a Credit Report has been submitted during the Daily Process (Step 780). Every account that has a LOC must be checked to see if a Credit Report is to be submitted (Step 780).

This ends this method 700 and returns processing to 2-1.

This process takes place on a daily basis to check if PDDP's have arrived before, on or after the date that the PDDP is scheduled to arrive.

### Daily Process for Credit Builder

In this case the PDDP is less than the LOC which resides on the database 308 (Step 752).

The ledger core control unit 305 issues a call to the account holder's account record which resides on the database 308 to remove the period-to-date transactions from the LOC which resides on the database 308 (Step 753).

The ledger core control unit 305 issues a call to the account holder's account record which resides on the database 308 to set a new LOC to be equal to the received PDDP amount (Step 754).

The ledger core control unit 305 issues a call to the account holder's account record which resides on the database 308 to debit the transactions from the account holder's DDA, which resides on the database 308 (Step 755).

The ledger core control unit 305 issues a call to the account holder's account record which resides on the database 308 to release the security holds from the account holder's DDA, which resides on the database 308 (Step 756).

The ledger core control unit 305 issues a call to the account holder's account record which resides on the database 308 to see if the transaction is in the grace period, which resides on the database 308; if so (Step 757).

The ledger core control unit 305 reports a “on time payment” to Experion 316a and any other credit bureaus 316 via the credit builder module 310 and the Metro2 module 312 and the credit bureau connection 315 (Step 760).

The method 700 terminates and returns processing to 2-1.

This method takes place on a daily basis to check if PDDP's have arrived before, on or after the date that the PDDP is scheduled to arrive.

### Daily Process for Credit Builder

In this case the PDDP is more than the LOC, which resides on the database 308 (Step 761).

The ledger core control unit 305 issues a call to the account holder's account record which resides on the database 308 to remove the period-to-date transactions from the LOC which resides on the database 308 (Step 762).

The ledger core control unit 305 issues a call to the account holder's account record which resides on the database 308 to debit the transaction from the DDA which resides on the database 308 (Step 763).

The ledger core control unit 305 issues a call to the account holder's account record which resides on the database 308 to release the security holds from the account holder's DDA, which resides on the database 308 (Step 764).

The ledger core control unit 305 issues a call to the account holder's account record which resides on the database 308 to post the difference between the PDDP and the LOC to the DDA all of which reside on the database 308 (Step 765).

The ledger core control unit 305 issues a call to the account holder's account record which resides on the database 308 to see if the transaction is in the grace period, which resides on the database 308 (Step 766).
If no, the ledger core control unit 305 reports a “ ” to Experion 316a and any other credit bureaus 316 via the credit builder module 310 and the Metro2 module 312 and the credit bureau connection 315 (Step 767).
If yes, the system reports on-time payment to the Credit Bureau 316 (Step 768).

Finally, the ledger core control unit 305 issues a call to the account holder's account which resides on the database 100 to turn the grace period flag off which resides on the database 100 to “off”(Step 769).

Next the Credit Report Submitted flag is turned on indicating a Credit Report has been submitted during the daily process (Step 781). Every bank account that has a LOC must be checked to see if a Credit Report has been or is to be submitted (Step 781).

The method 700 ends and returns processing to 2-1.

This process takes place on a daily basis to check if PDDP's have arrived before, on or after the date that the PDDP is scheduled to arrive.

### Daily Process for Credit Builder

In this case the PDDP is more than the LOC, which resides on the database 308 (Step 761).

The ledger core control unit 305 issues a call to the account holder's account record which resides on the database 308 to remove the period-to-date transactions from the LOC which resides on the database 308 (Step 762).

The ledger core control unit 305 issues a call to the account holder's account record which resides on the database 308 to debit the transaction from the DDA which resides on the database 308 (Step 763).

The ledger core control unit 305 issues a call to the account holder's account record which resides on the database 308 to release the security holds from the account holder's DDA, which resides on the database 308 (Step 764).

The ledger core control unit 305 issues a call to the account holder's account record which resides on the database 308 to post the difference between the PDDP and the LOC to the DDA all of which reside on the database 308 (Step 765).

The ledger core control unit 305 issues a call to the account holder's account record which resides on the database 308 to see if the transaction is in the grace period, which resides on the database 308; if so (Step 766).

The ledger core control unit 305 reports an “on time payment” to Experion 316a and any other credit bureaus 316 via the credit builder module 310 and the Metro2 module 312 and the credit bureau connection 315 (Step 768).

The method 700 terminates and returns processing to 2-1.

### Daily Process (2) for Credit Builder

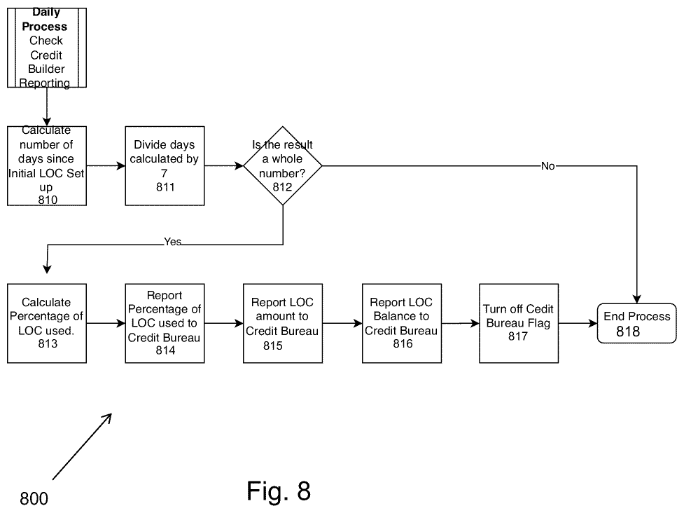

Referring now to the method 800 of FIG. 8 with system 300 of FIG. 3, every bank account associate with the present debit card is processed every day in accordance with method 800.

System 300 checks to see if seven (7) days have passed since the last periodic report has been 69 to the Credit Bureau 316 (Step 810). The system 300, which is running on the Ledger Core Control Unit 305, calculates the number of days since the LOC was set up (Step 810).

The Ledger Core Control Unit 305 divides the number of days calculated in 170 by 7 (Step 811). If the number of days divided by 7 is a whole number (Step 812), method 800 to Step 813. If not, method 800 ends (Step 818).

With the number of days divided by seven being a whole number, the Ledger Core Control Unit 305 calculates the percentage of the LOC that has been used (Step 813) and the Ledger Core Control Unit 305 reports the percentage of the LOC that has been used to the Credit Bureau 316 (Step 814). Ledger Core Control Unit 305 also initiates a call to an AcctHdr's account which resides on the Database 308 to obtain the LOC and reports this amount to the Credit Bureau 316 (Step 815). Finally, the Ledger Core Control Unit 305 turns off the Credit Report submitted flag (Step 816) and method 800 ends (Step 818).

Next, Ledger Core Control Unit 305 initiates a call to an AcctHdr's account (residing in Database 308) to see obtain the LOC Balance and reports this amount to the Credit Bureau 316 (Step 816).

It will now be clear that the present method and system provides features and advantages not found in prior method and systems for conducting purchases. Unlike a conventional debit card, the present method and system allows one to use a debit card to build one's credit history.

Further, unlike credit cards which a customer may carry a balance and thus incur debt, the present method and system allows one to build credit without the possibility of going into debt. This is accomplished by using a debit card which has a credit line account created with a line of credit allowing the debit card issuer to record purchase transactions and payment of the line of credit from a customer's bank account with a credit bureau.

In addition, unlike a conventional debit card in which funds are directly withdrawn from the customer's bank account as the debit card is used for making purchases, the present method and system does not withdraw funds from the bank account at the time a purchase is made. Instead, funds are transferred periodically from the bank account to the debit card issuer periodically such as monthly when the debit card issuer requires payment such as on a monthly basis. Accordingly, unlike conventional debit cards and debit card issuers, the present method and system creates a novel credit line account associated with the bank account having a debit card. This allows the present method and system to be used to build credit for the customer using a debit card.

Further, unlike a secure credit card in which a customer deposits money in an account that the customer cannot use for cash withdrawal, the present debit card account allows a customer to make cash withdrawals from that account.

1. A method for building credit using a bank account and an associated debit card, the method comprising:
opening a bank account with a debit card issuer by a customer, the bank account having a bank account balance and having an associate debit card;
creating a credit line account for the customer having an initial credit line account amount equal to the bank account balance;
using the debit card for a purchase amount with a merchant in a purchase transaction, the purchase amount transferred from the debit card issuer to the merchant, the purchase amount deducted from the credit line account amount balance, and an encumbered hold placed on the bank account in the amount of the purchase price, thus reducing an amount that the customer can withdraw from the bank account by the purchase price amount although an actual amount of money in the bank account remains at the bank account balance amount;
transferring periodically money from the bank account to the debit card issuer in an amount of reductions to the credit line account balance thus restoring the credit line account balance; and
reporting to credit bureau the purchase transaction and restoration of the credit line account amount balance, thereby establishing a credit history for the customer with the credit bureau.

2. The method of claim 1, further comprising establishing direct deposit between an employer for the customer and the bank account, wherein funds to the bank account are made directly between the employer and the debit card issuer to replenish funds in the bank account.

3. The method of claim 1, wherein the bank account is one of a savings account and a checking account, and wherein a customer may make withdrawals from the bank account, thereby reducing the balance in the bank account by the with withdrawal amounts and the credit line account balance is also reduced by the withdrawal amounts.

4. The method of claim 1, wherein the transferring periodically money from the bank account to the debit card issuer is transferred monthly.

5. A method for receiving payment for a purchase from a customer using a debit card, the method comprising:
establishing a payment network between a merchant and a debit card issuer,
requesting payment by the merchant to the debit card issuer in an amount a customer is initiating a purchase transaction at a purchase price amount, and
receiving the payment by the merchant from the debit card issuer in the purchase price amount, wherein funds are transferred from the debit card issuer to the merchant from a debit card issuer account and not an account of the customer, wherein the customer has a bank account having a bank account balance and having associate debit card from the debit card issuer, the debit card issuer having extended a credit line account for the customer having an initial credit line account amount equal to the bank account balance, the purchase amount is deducted from the credit line account amount balance, an encumbered hold is placed on the bank account in the amount of the purchase price, thus reducing an amount that the customer can withdraw from the bank account by the purchase price amount although the actual amount of money in the bank account remains at the bank account balance amount, money being periodically transfer from the bank account to the debit card issuer in an amount of reductions to the credit line account balance thus restoring the credit line account balance, wherein the debit card issuer reports to credit bureau the purchase transaction and restoration of the credit line account amount balance, thereby establishing a credit history for the customer with the credit bureau.

6. The method of claim 5, further comprising establishing direct deposit between an employer for the customer and the bank account, wherein funds to the bank account are made directly between the employer and the debit card issuer to replenish funds in the bank account.

7. The method of claim 6, wherein the bank account is one of a savings account and a checking account, and wherein a customer may make withdrawals from the bank account, thereby reducing the balance in the bank account by the with withdrawal amounts and the credit line account balance is also reduced by the withdrawal amounts.

8. A system for building credit using a bank account and an associated debit card, the system comprising:
a credit builder module associated with a debit card issuer, the credit builder module having a processor and computer memory,
a plurality of network connections allowing connectivity between the credit builder module and customers, credit bureau and merchant;
the credit builder module:
establishing a bank account with a debit card issuer for a customer, the bank account having a bank account balance and having an associate debit card; and
hosting a credit line account for the customer having an initial credit line account amount equal to the bank account balance;
facilitating transfer of a purchase amount between the debit card issuer and a merchant in a purchase amount a customer made a purchase transaction using the debit card, the credit builder deducting the purchase from the credit line account amount balance, and the credit builder module placing an encumbered hold placed on the bank account in the amount of the purchase price, thus reducing an amount that the customer can withdraw from the bank account by the purchase price amount although an actual amount of money in the bank account remains at the bank account balance amount;
transferring periodically money from the bank account to the debit card issuer in an amount of reductions to the credit line account balance thus restoring the credit line account balance; and
reporting to credit bureau the purchase transaction and restoration of the credit line account amount balance, thereby establishing a credit history for the customer with the credit bureau.

9. The system of claim 8, wherein the credit builder module further comprising establishing direct deposit between an employer for the customer and the bank account, wherein funds to the bank account are made directly between the employer and the debit card issuer to replenish funds in the bank account.

10. The system of claim 9, wherein the bank account is one of a savings account and a checking account, and wherein a customer may make withdrawals from the bank account, thereby reducing the balance in the bank account by the with withdrawal amounts and the credit line account balance is also reduced by the withdrawal amounts.

11. The system of claim 8, wherein the transferring periodically money from the bank account to the debit card issuer is transferred monthly.
